(19) United States
(12) Patent Application Publication
(10) Pub. No.: US 2021/0061053 A1
(43) Pub. Date: Mar. 4, 2021

(54) System and Method of Vehicle Climate Control Using Window Optical Properties

(71) Applicant: GM GLOBAL TECHNOLOGY OPERATIONS LLC, Detroit, MI (US)

(72) Inventors: Alok WAREY, Novi, MI (US); Shailendra KAUSHIK, Novi, MI (US); Bahram KHALIGHI, Birmingham, MI (US); Taeyoung HAN, Bloomfield Hills, MI (US); Paul E. KRAJEWSKI, Troy, MI (US)

(21) Appl. No.: 16/550,921

(22) Filed: Aug. 26, 2019

(51) Int. Cl. B60H 1/00; B60J 3/04; G05D 23/19

(52) U.S. Cl. CPC B60H 1/0075; G05D 23/1919; B60J 3/04; B60H 1/00814

(57) ABSTRACT

A climate control system in a vehicle. The system comprises a first control module configured to: i) receive a first temperature measurement associated with a passenger compartment of a vehicle; ii) compare the first temperature measurement to a temperature set point value; and iii) in response to the comparison, determine a first error value associated with a difference between the first temperature measurement and the temperature set point. The system further comprises a temperature control module configured to receive the first error value and, in response, to adjust the light transmissivity of at least one window the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates apparatuses and methods of controlling the climate in the passenger compartment of a vehicle. Heating, ventilation, and air conditioning (HVAC) systems are widely used to cool and to heat passenger compartments. However, the power drain of HVAC systems significantly reduce the gas mileage in combustion engine vehicles as well as the battery life of electric vehicles.

### SUMMARY

It is an object of the present disclosure to provide a climate control system in a vehicle. The system comprises a first control module configured to: i) receive a first temperature measurement associated with a passenger compartment of a vehicle; ii) compare the first temperature measurement to a temperature set point value; and iii) in response to the comparison, determine a first error value associated with a difference between the first temperature measurement and the temperature set point. The system further comprises a temperature control module configured to receive the first error value and, in response, to adjust the light transmissivity of at least one window the vehicle.

In one embodiment, the temperature control module adjusts the light transmissivity of the at least one window in order to reduce the first error value.

In another embodiment, the temperature control module increases the light transmissivity of the at least one window in order to reduce the first error value.

In still another embodiment, the temperature control module decreases the light transmissivity of the at least one window in order to reduce the first error value.

In yet another embodiment, after the temperature control module adjusts the light transmissivity of the at least one window the vehicle, the first control module is further configured to: i) receive a second temperature measurement associated with the passenger compartment of the vehicle; ii) compare the second temperature measurement to a temperature set point value; and ii) in response to the comparison, determine a second error value associated with a difference between the second temperature measurement and the temperature set point.

In a further embodiment, the temperature control module is further configured to receive the second error value and, in response, to adjust a setting of a heating, ventilation and air conditioning (HVAC) module of the vehicle.

In a still further embodiment, the temperature control module adjusts the setting of the HVAC module in order to reduce the second error value.

In a yet further embodiment, the temperature control module adjusts a blower speed of the HVAC module in order to reduce the second error value.

In one embodiment, the temperature control module adjusts a mode of the HVAC module in order to reduce the second error value.

In another embodiment, the temperature control module adjusts a temperature of air exiting the HVAC module in order to reduce the second error value.

It is another object of the present disclosure to provide a method of climate control in a vehicle. The method of controlling a climate of a passenger compartment of a vehicle comprises: i) receiving a first temperature measurement associated with a passenger compartment of a vehicle; ii) comparing the first temperature measurement to a temperature set point value; and iii) in response to the comparison, determining a first error value associated with a difference between the first temperature measurement and the temperature set point. The method further comprises, in response to the first error value, adjusting the light transmissivity of at least one window the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a high-level diagram of an electric vehicle including a climate control system according to an embodiment of the disclosure.

FIG. 2 is a more detailed diagram of the climate control module in FIG. 1 according to an embodiment of the disclosure.

FIG. 3 is a flow diagram illustrating the adjustment of window transmissivity according to an embodiment of the disclosure.

FIG. 4 is a flow diagram illustrating the adjustment of HVAC settings in conjunction with adjusting window transmissivity according to an embodiment of the disclosure.

In the drawings, reference numbers may be reused to identify similar and/or identical elements.

### DETAILED DESCRIPTION

The present disclosure describes a vehicle climate control system that tunes the glazing properties of all window surfaces in the vehicle for thermal comfort and/or for reducing the energy consumption of the heating, ventilation, and air conditioning (HVAC) system of the vehicle. Reducing the energy consumption of the HVAC system is particularly useful in an electric vehicle (EV) that operates on battery power, since energy consumption increases the effective EV vehicle range.

The present disclosure also introduces the concept of an Equivalent Homogeneous Temperature (EHT) value. The EHT value may be defined as “the uniform temperature of an imaginary enclosure with air velocity equal to zero in which a person exchanges the same dry heat by radiation and convection as in an actual non-uniform environment”. The EHT value provides a single representative value to characterize a “non-uniform” thermal environment into a uniform thermal environment. By way of example, the actual environment inside the passenger compartment of a vehicle may exhibit significant temperature variations between dark surfaces and light surfaces, between the space near the roof and the space near the floor, and so forth. The EHT value provides a single uniform value to represent the non-uniform temperature inside the passenger compartment. The EHT value may vary over time according to the solar load (i.e., amount of sunlight) on the vehicle, the ambient air temperature, the number of passengers, and the like.

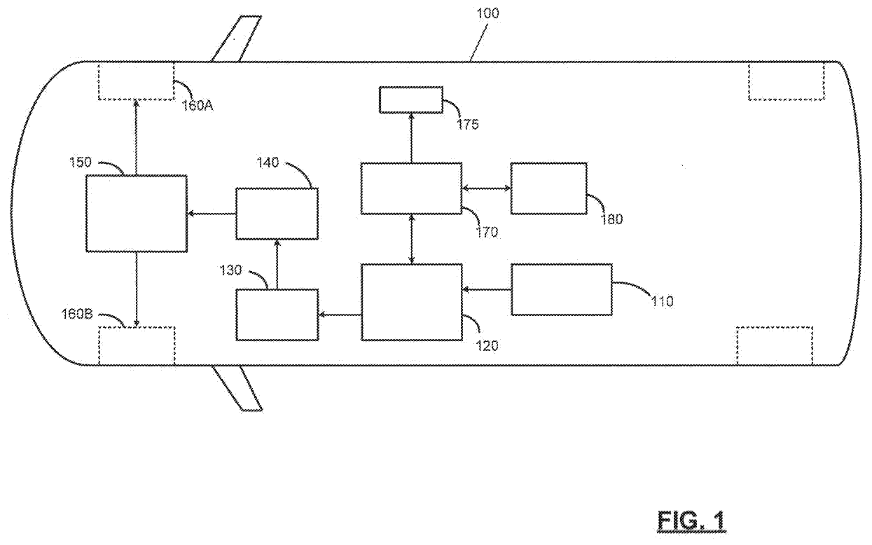

FIG. 1 is a high-level diagram of an electric vehicle 100 including a climate control system according to an embodiment of the disclosure. Electric vehicle 100 comprises battery controller module 110, battery pack 120, power converter 130, electric motor 140, transmission 150, and wheels 160A and 160B. The climate control system of vehicle 100 comprises climate control module 170, heating, ventilation, and air conditioning (HVAC) module 175, and sensors module 180.

Battery controller module 110 controls the charging of a plurality of battery cells in battery pack 120. Power converter 130 receive DC power output from battery pack 120 and converts the DC power to an AC output voltage that is applied to electric motor 120. The output torque of electric motor 140 is applied to transmission 150, which turns wheels 160A and 160B. In one embodiment, transmission 150 may be, for example, a single gear transmission. The speed and acceleration of vehicle 100 is controlled by the level of AC output voltage from power converter 130. The AC output voltage of power converter 130 is, in turn, controlled by the accelerator pedal (not shown) in vehicle 100.

Sensors module 180 comprises a variety of sensors. These sensors may include, for example, a thermostat for sensing the temperature in the passenger compartment and a thermostat for sensing the ambient air temperature outside the passenger compartment. These sensors may also include an infrared camera configured to sense thermal radiation inside the passenger compartment, including thermal radiation from one or more passengers. These sensors may further include one or more solar cells for detecting the position and angle of the sun and determining the amount of sunlight (i.e., solar load) on the surfaces of the vehicle.

According to the principles of the present disclosure, climate control module 170 receives sensor input data from sensors module 180 and, in response, adjusts the glazing of one or more of the vehicle windows and the settings of HVAC module 175. Adjusting the glazing of the windows adjusts the light transmissivity of each window. Currently, some types of aircraft incorporate windows in the passenger cabin that enable each passenger to use a control button to adjust the glazing of the window next to his or her seat.

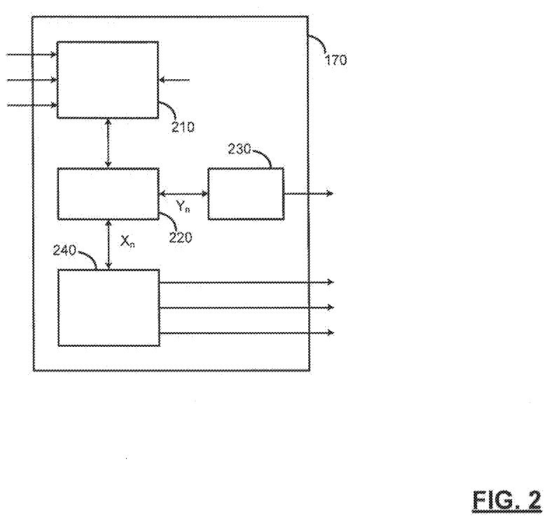

FIG. 2 is a more detailed diagram of the climate control module 170 in FIG. 1 according to an embodiment of the disclosure. The climate control module 170 comprises an equivalent homogeneous temperature (EHT) Set Point control module 210, a temperature control module 220, glazing control module 230, and an HVAC control module 240. The EHT Set Point control module 210 receives an EHT set point value for the vehicle passenger compartment that may be determined by system design. As noted above, the EHT value provides a single representative value to characterize a “non-uniform” thermal environment into a uniform thermal environment. The EHT Set Point control module 210 also receives from sensors module 180 a variety of input measurements, including a temperature reading (from a thermostat), an infrared (IR) image (from a camera), and a solar load input (from a solar sensor) that indicated the amount of sunlight on the vehicle and, therefore, entering the passenger compartment. The solar load input may indicate the direction, elevation angle, and intensity of the sun, among other things.

The EHT Set Point control module 210 determines from one or more of the inputs from sensors module 180 the actual EHT value in the passenger compartment. The EHT Set Point control module 210 then compares the actual EHT value to the EHT Set Point value to produce an error signal ΔEHT that indicates if the actual EHT value is higher or lower and by how much. (i.e., magnitude of difference).

In some embodiments, the error may be the difference between the actual measured temperature and a target temperature. However, in other embodiments, the error may be the difference between a calculated EHT under the current vehicle conditions and what the EHT should be for those vehicle conditions (i.e., the EHT Set Point).

The temperature control module 220 receives the error signal ΔEHT and, in response, may adjust the window glazing or the A/C settings, or both, in order to reduce or to eliminate the error signal ΔEHT. The temperature control module 220 adjusts the window glazing by sending a control value Yₙ to the glazing control module 230. The control value Yₙ may cause the glazing control module 230 to reduce light transmissivity in order to cool the passenger compartment or may cause the glazing control module 230 to increase light transmissivity in order to warm the passenger compartment. The temperature control module 220 adjusts the HVAC settings by sending a control value Xₙ to the HVAC control module 230. The HVAC settings include HVAC mode (i.e., heat or cool), exit air temperature (warmer or cooler), and blower speed (i.e., fan speed). The control value Xₙ may cause the HVAC control module 230 to cool the passenger compartment or may cause the HVAC control module 230 to warm the passenger compartment.

According to an advantageous embodiment, the glazing control module 230 may execute one or more artificial intelligence (AI) or machine learning (ML) algorithms. The AI/ML algorithms may determine the optimal glazing composition based on the EHT set point and one or more input boundary conditions, such as the solar load, the outside air temperature, the HVAC discharge temperature, and the like. Preferably, the AI/ML algorithms may be pre-trained on a dataset that encompasses any environmental condition the vehicle may encounter.

According to the principles of the present disclosure, climate control module 170 will try to control temperature by adjusting window glazing first. If adjusting the light transmissivity is sufficient to maintain the EHT value, then it will not be necessary to turn on the HVAC module 175 or to increase the amount of heating or cooling done by the HVAC module 175. If adjusting the light transmissivity is not sufficient to maintain the EHT value, only then will it be necessary to turn on the HVAC module 175 or to increase its power consumption. The enables significant power savings since adjusting the window glazing requires a very small amount of power compared to the HVAC module 175.

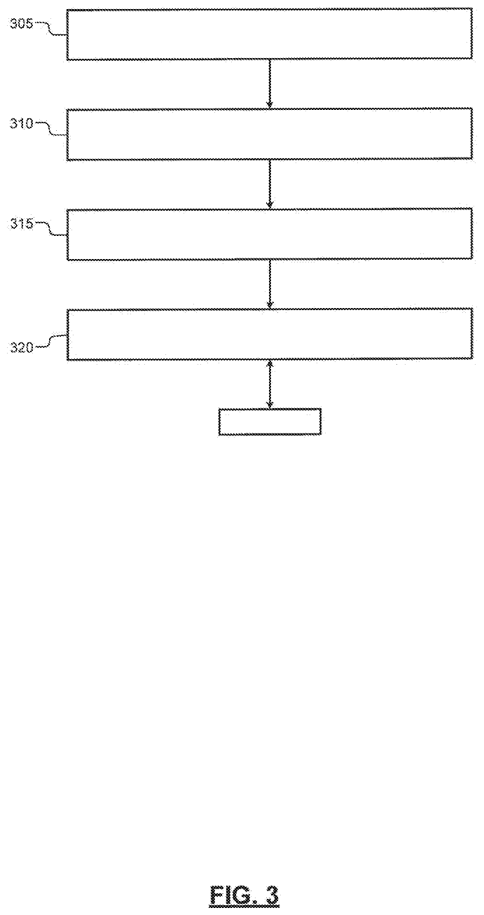

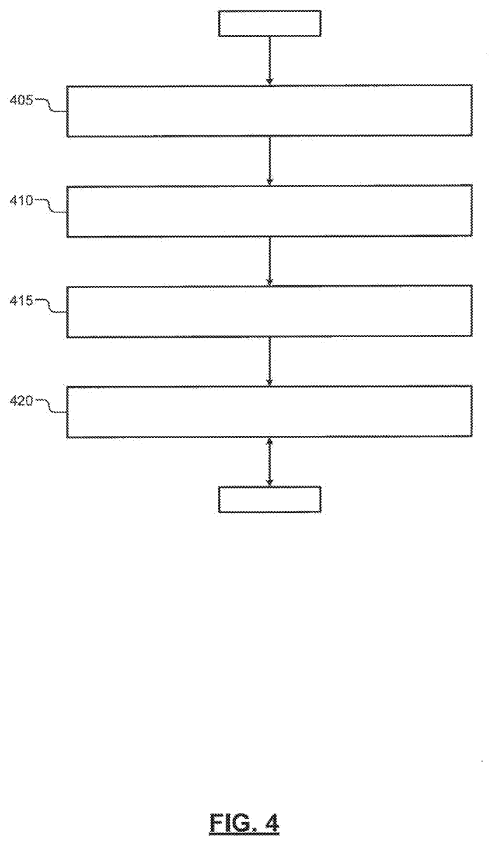

FIG. 3 is a flow diagram illustrating the adjustment of window transmissivity according to an embodiment of the disclosure. FIG. 4 is a flow diagram illustrating the adjustment of HVAC settings in conjunction with adjusting window transmissivity according to an embodiment of the disclosure.

Initially, in 305, the EHT set point control module 210 receives sensor inputs and calculates the cabin EHT value and/or determines the occupant temperature from, for example, an IR image. In 310, the EHT set point control module 210 compares the cabin EHT to the EHT Set Point and determines the ΔEHT control error value. In 315, the temperature control module 220 uses the ΔEHT control error value to determine the Yₙ control value. In 320, the glazing control module 230 uses the Yₙ control value to adjust light transmissivity of one or more vehicle windows. Depending on the direction and elevation of the sun, it may be necessary to adjust the light transmissivity of only those window(s) that actually face the sun.

In 405, after the window glazing has been adjusted, the EHT set point control module 210 reassesses the cabin EHT and/or the occupant temperature. In 410, the EHT set point control module 210 compares the cabin EHT to the EHT Set Point and again determines the ΔEHT control error value. In 415, the temperature control module 220 uses the ΔEHT control error value to determine the Xₙ control value. In 420, the HVAC control module 240 uses the Xₙ control value to adjust one or more of exit (discharge) air temperature, the blower speed, and the HVAC mode in order to increase or to decrease the cabin temperature.

Thereafter, the climate control module 170 may return to 305 in order to adjust iteratively one or both of the window glazing and the HVAC settings. In this way, the climate control module 170 tunes the glazing properties of all window surfaces in the vehicle for thermal comfort and reduces the energy consumption of the HVAC system of the vehicle.

In the embodiments described above, the light transmissivity of the windows of the vehicle is controlled by adjusting the window glazing. However, this is by way of example only and should not be construed to limit the scope of the disclosure. In alternate embodiments of the disclosure, the light transmissivity of one or more of the windows of the vehicle 100 may be controlled by other types of smart glass technologies, including electrochromic, photochromic, thermochromic, and the like.

In some embodiments of the disclosure, the light transmissivity of individual windows may be adjusted for individual passengers in the vehicle 100. In such embodiments, the EHT Set Point control module 210 may receive, for example, individual IR images for each passenger and may calculate an individual ΔEHT control error value for each passenger. This enables the temperature control module 220 to generate multiple Yₙ control values to adjust the light transmissivity of each window separately.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system in a vehicle comprising:
a first control module configured to:
receive a first temperature measurement associated with a passenger compartment of a vehicle;
compare the first temperature measurement to a temperature set point value; and
in response to the comparison, determine a first error value associated with a difference between the first temperature measurement and the temperature set point; and
a temperature control module configured to receive the first error value and, in response, to adjust the light transmissivity of at least one window of the vehicle.

2. The system of claim 1, wherein the temperature control module adjusts the light transmissivity of the at least one window in order to reduce the first error value.

3. The system of claim 2, wherein the temperature control module increases the light transmissivity of the at least one window in order to reduce the first error value.

4. The system of claim 2, wherein the temperature control module decreases the light transmissivity of the at least one window in order to reduce the first error value.

5. The system of claim 1, wherein after the temperature control module adjusts the light transmissivity of the at least one window the vehicle, the first control module is further configured to:
receive a second temperature measurement associated with the passenger compartment of the vehicle;
compare the second temperature measurement to a temperature set point value; and
in response to the comparison, determine a second error value associated with a difference between the second temperature measurement and the temperature set point.

6. The system of claim 5, wherein the temperature control module is further configured to receive the second error value and, in response, to adjust a setting of a heating, ventilation and air conditioning (HVAC) module of the vehicle.

7. The system of claim 6, wherein the temperature control module adjusts the setting of the HVAC module in order to reduce the second error value.

8. The system of claim 6, wherein the temperature control module adjusts a blower speed of the HVAC module in order to reduce the second error value.

9. The system of claim 6, wherein the temperature control module adjusts a mode of the HVAC module in order to reduce the second error value.

10. The system of claim 6, wherein the temperature control module adjusts a temperature of air exiting the HVAC module in order to reduce the second error value.

11. A method of controlling a climate of a passenger compartment of a vehicle comprising:
receiving a first temperature measurement associated with a passenger compartment of a vehicle;
comparing the first temperature measurement to a temperature set point value;
in response to the comparison, determining a first error value associated with a difference between the first temperature measurement and the temperature set point; and
in response to the first error value, adjusting the light transmissivity of at least one window of the vehicle.

12. The method of claim 11, wherein adjusting the light transmissivity of the at least one window reduces the first error value.

13. The method of claim 12, wherein adjusting the light transmissivity of the at least one window comprises increasing the light transmissivity of the at least one window in order to reduce the first error value.

14. The method of claim 12, wherein adjusting the light transmissivity of the at least one window comprises decreasing the light transmissivity of the at least one window in order to reduce the first error value.

15. The method of claim 11, further comprising, after the temperature control module adjusts the light transmissivity of the at least one window the vehicle:
receiving a second temperature measurement associated with the passenger compartment of the vehicle;
comparing the second temperature measurement to a temperature set point value; and
in response to the comparison, determining a second error value associated with a difference between the second temperature measurement and the temperature set point.

16. The method of claim 15, further comprising, in response to the second error value, adjusting a setting of a heating, ventilation and air conditioning (HVAC) module of the vehicle.

17. The method of claim 16, wherein adjusting the setting of the HVAC module reduces the second error value.

18. The method of claim 16, wherein adjusting the setting of the HVAC module comprises adjusting a blower speed of the HVAC module in order to reduce the second error value.

19. The method of claim 16, wherein adjusting the setting of the HVAC module comprises adjusting a mode of the HVAC module in order to reduce the second error value.

20. The method of claim 16, wherein adjusting the setting of the HVAC module comprises adjusting a temperature of air exiting the HVAC module in order to reduce the second error value.
